(19) United States
(12) Patent Application Publication
(10) Pub. No.: US 2011/0262815 A1
(43) Pub. Date: Oct. 27, 2011

(54) LITHIUM POLYMER BATTERY

(75) Inventors: Su-Hee HAN, Yongin-si (KR); Jin-Sung KIM, Yongin-si (KR); Jin-Hyunk LIM, Yongin-si (KR); Na-Rae PARK, Yongin-si (KR); Mi-Hyeun OH, Yongin-si (KR)

(73) Assignee: SAMSUNG SDI CO., LTD. (SDI), Yongin-si (KR)

(21) Appl. No.: 12/976,040

(22) Filed: Dec. 22, 2010

(30) Foreign Application Priority Data
Apr. 26, 2010 (KR) 10-2010-0038530

(51) Int. Cl. H01M 10/056

(52) U.S. Cl. 429/303; 429/324; 429/306

(57) ABSTRACT

A lithium polymer battery includes a polymer electrolyte or a gel polymer electrolyte having a nonaqueous organic solvent, a lithium salt, an ion-conducting polymer and a fluorinated benzene; a positive electrode; and a negative electrode.

### CLAIM OF PRIORITY

This application makes reference to, incorporates the same herein, and claims all benefits accruing under 35 U.S.C. §119 from an application for a LITHIUM POLYMER BATTERY earlier filed in the Korean Intellectual Property Office on the 26 Apr. 2010 and there duly assigned Serial No. 10-2010-0038530.

### BACKGROUND OF THE INVENTION

1. Field of the Invention

The present invention relates to a lithium polymer battery including a polymer electrolyte, and more particularly, to a gel polymer electrolyte including a nonaqueous organic solvent, a lithium salt, an ion-conducting polymer, and fluorinated benzene.

2. Description of the Related Art

Lithium secondary batteries include a positive electrode, a negative electrode, and an electrolyte solution arranged to convert chemical energy generated by electrochemical reduction and oxidation reaction (i.e., a “redox” reaction) of chemical substances into electrical energy.

Lithium secondary batteries are currently widely used as power sources in portable electronic devices, such as mobile phones, and these uses of lithium secondary batteries are becoming more significant.

If an uncharged zone occurs in an electrode of a lithium secondary battery, the initial formation of the electrical capacity and the lifetime characteristics of a lithium polymer battery may be degraded.

### SUMMARY OF THE INVENTION

One or more embodiments of the present invention include a polymer electrolyte of a lithium polymer battery with improved capacity and lifetime characteristics.

One or more embodiments of the present invention include a gel polymer electrolyte of a lithium polymer battery with improved capacity and lifetime characteristics.

Additional aspects will be set forth in part in the following description and, in part, will be apparent from the description, or may be learned by practice of the disclosed embodiments of the principles of the present invention.

According to the principles of the present invention, a lithium polymer battery may be constructed with a polymer electrolyte including a nonaqueous organic solvent, a lithium salt, an ion-conducting polymer, and fluorinated benzene; a positive electrode; and a negative electrode.

According to the principles of the present invention, a lithium polymer battery may be constructed with a gel polymer electrolyte including a nonaqueous organic solvent, a lithium salt, an ion-conducting polymer and fluorinated benzene; a positive electrode; and a negative electrode.

The fluorinated benzene includes at least one material selected from a group that includes hexafluorobenzene, pentafluorobenzene, 1,2,3,4-tetrafluorobenzene, 1,2,3,5-tetrafluorobenzene, 1,2,4,5-tetrafluorobenzene, and 1,2,3-trifluorobenzene.

The amount of the fluorinated benzene may be in a range of about 0.3 to about 10 parts by weight based on 100 parts by weight of a total weight of the nonaqueous organic solvent and the lithium salt.

The amount of the ion-conducting polymer may be in a range of about 1 to about 30 parts by weight based on 100 parts by weight of a total weight of the nonaqueous organic solvent and the lithium salt.

The ion-conducting polymer may include a product of polymerization between a (meth)acrylic polymer and a (meth)acrylic monomer.

The (meth)acrylic monomer may include 2-ethylhexylacrylate or 2-ethylhexylmethacrylate.

The amount of the (meth)acrylic monomer may be within a range of about 10 to about 50 parts by weight based on 100 parts by weight of the (meth)acrylic polymer.

The (meth)acrylic polymer may include a polyethylene oxide having a (meth)acryl group.

The ion-conducting polymer may include a product of polymerization between a (meth)acrylic polymer and a (meth)acrylic monomer, and the amount of the (meth)acrylic monomer may be within a range of about 10 to about 50 parts by weight based on 100 parts by weight of the (meth)acrylic polymer.

The amount of the fluorinated benzene generated after an activation process at a temperature within a range that extends from about 20 to about 25° C. may be in a range of about 0.3 to about 10 parts by weight based on 100 parts by weight of a total weight of the nonaqueous organic solvent and the lithium salt.

The amount of the ion-conducting polymer generated after an activation process at a temperature within a range that extends from about 20 to about 25° C. may be in a range of about 1 to about 30 parts by weight based on 100 parts by weight of a total weight of the nonaqueous organic solvent and the lithium salt.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a schematic perspective view of a lithium polymer battery constructed as an embodiment of the present invention;

FIG. 2 is a graph illustrating the capacity of a number of charge-discharge cycles of lithium polymer batteries manufactured according to Examples 1 through 4 and Comparative Example 1;

FIG. 3 is a graph illustrating the capacity retention rate with respect to an amount of hexafluorobenzene in lithium polymer batteries manufactured according to Examples 1 through 4, Example 6 and Comparative Example 1;

FIG. 4 is a graph illustrating the lifetime characteristics of rectangular lithium batteries manufactured according to Comparative Examples 2 and 3 after a high-temperature activation at 45° C.;

FIG. 5 is a graph illustrating the lifetime characteristics of rectangular lithium batteries manufactured according to Comparative Examples 2 and 3 after a room-temperature activation at 25° C.; and

FIG. 6 is a flowchart illustrating a process of making a positive electrode.

### DETAILED DESCRIPTION OF THE INVENTION

The general inventive concept is described in detail below with reference to the accompanying drawings. Reference will now be made in detail, in which embodiments, examples of the present invention are shown which are illustrated in the accompanying drawings, wherein like reference numerals refer to the like elements throughout. In this regard, the present invention may be embodied in many different forms and should not be construed as being limited to the embodiments set forth herein. Rather, these embodiments are provided so that this disclosure will be thorough and complete, and will fully convey the concept of the present invention to those skilled in the art. Accordingly, the embodiments are merely described below, by referring to the drawings, to explain aspects of the present invention. Like reference numerals in the drawings refer to like elements throughout, and thus their description have not been repeated. In the following description, the acronym “CC/CV mode” refers to a test mode during which the cell of a battery, being subjected to testing is charged with a constant electrical current exhibiting a constant amplitude of voltage.

A lithium polymer battery according to an embodiment of the present invention includes: a polymer electrolyte containing a nonaqueous organic solvent, a lithium salt, an ion-conducting polymer, and a fluorinated benzene; a positive electrode; and a negative electrode.

The fluorinated benzene, which is a benzene having a fluorine group, may be at least one selected from the group that includes hexafluorobenzene, pentafluorobenzene, 1,2,3,4-tetrafluorobenzene, 1,2,3,5-tetrafluorobenzene, 1,2,4,5-tetrafluorobenzene, and 1,2,3-trifluorobenzene. For example, the fluorinated benzene may be hexafluorobenzene.

The amount of the fluorinated benzene may be in a range of about 0.3 to about 10 parts by weight based on 100 parts by weight of the total weight of the nonaqueous organic solvent and the lithium salt. When the amount of the fluorinated benzene is within this range, an area of uncharged zones that likely occur in electrodes of a lithium polymer battery is reduced. Therefore, the lithium polymer battery has excellent a initial formation capacity and lifetime characteristics.

The ion-conducting polymer may be any matrix resin for forming polymer electrolytes. Examples of the ion-conducting polymer include a vinylidene fluoride/hexafluoropropylene copolymer, polyvinylidenefluoride, polyacrylonitrile, polymethylmethacrylate, and a mixture of these substances. For example, a vinylidenefluoride/hexafluoropropylene copolymer containing about 8 to about 25 wt % of hexafluoropropylene, or a product of polymerization between a (meth)acrylic polymer and a (meth)acrylic monomer may be used.

The ion-conducting polymer may be a product of polymerization between a (meth)acrylic polymer and a (meth)acrylic monomer, but the ion-conducting polymer is not limited thereto. When a product of polymerization between a (meth)acrylic polymer and a (meth)acrylic monomer is used as the ion-conducting polymer for a lithium polymer battery, the lithium polymer battery have excellent swelling and lifetime characteristics.

The (meth)acrylic polymer may be any polymer having an acryl group. For example, the (meth)acrylic polymer may be polyethyleneoxide (PEO) including an acryl group.

The polyethyleneoxide including an acryl group may have a weight average molecular weight of about 10,000 to about 300,000.

The polyethyleneoxide including an acryl group may be a compound represented by Formula 1 below:

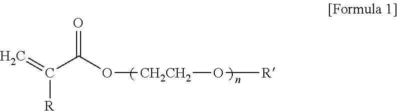

wherein R is a hydrogen atom or a C₁-C₅ alkyl group, and R′ is selected from the group that includes a hydrogen atom, a substituted or unsubstituted C₁-C₂₀ alkyl group, a substituted or unsubstituted C₆-C₂₀ aryl group, a substituted or unsubstituted C₄-C₂₀ carbon ring group, and a substituted or unsubstituted C₂-C₂₀ heterocyclic group, and where n is an integer from 1 to 100.

Examples of the C₁-C₅ alkyl group include a methyl group, an ethyl group, a propyl group, a butyl group, a pentyl group, and the like, but is not limited to these substances.

Examples of the substituted or unsubstituted C₁-C₂₀ alkyl group include a methyl group, an ethyl group, a propyl group, —CF₂CHFCHF₃, and the like, but is not limited to these substances.

Examples of the substituted or unsubstituted C₆-C₂₀ aryl group include a phenyl group, and the like, but is not limited to these substances.

The (meth)acrylic monomer is represented by Formula 2 below:

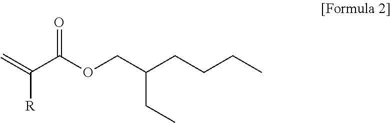

wherein R is a hydrogen atom or a C₁-C₁₅ alkyl group.

Examples of the (meth)acrylic monomer include 2-ethylhexylacrylate, 2-ethylhexylmethacrylate, and the like, but is not limited to these substances.

After a lithium polymer battery constructed as the current embodiment of the present invention is activated at a temperature within a range extending from about 20 to about 25° C. the amount of the fluorinated benzene may be in a range extending from about 0.3 to about 10 parts by weight based on 100 parts by weight of the total weight of the nonaqueous organic solvent and the lithium salt, and the amount of the ion-conducting polymer may be in a range extending from about 1 to about 30 parts by weight based on 100 parts by weight of the total weight of the nonaqueous organic solvent and the lithium salt.

The nonaqueous organic solvent contained in the electrolyte solution may function as a migration medium of Li ions involved in electrochemical reactions of the lithium battery.

The nonaqueous organic solvent should include a chain carbonate and a cyclic carbonate.

Examples of the chain carbonate include dimethyl carbonate (DMC), ethylmethyl carbonate (EMC), diethyl carbonate (DEC), methylpropyl carbonate (MPC), dipropyl carbonate (DPC), ethylpropyl carbonate (EPC), ethylmethyl carbonate (EMC), and the like, but is not limited to these substances.

Examples of the cyclic carbonate include ethylene carbonate (EC), propylene carbonate (PC), and the like, but is not limited to these substances.

The total amount of the chain carbonate may be in a range of about 50 to about 90 parts by volume based on 100 parts by volume of the nonaqueous organic solvent.

The nonaqueous organic solvent may further include at least one first material selected from the group that includes an ester solvent, an ether solvent, a ketone solvent, an alcohol solvent, and an aprotic solvent.

The ester solvent may be methyl acetate, ethyl acetate, n-propyl acetate, dimethyl acetate, methyl propionate, ethyl propionate, γ-butylolactone, decanolide, valerolactone, mevalonolactone, caprolactone, or the like, but is not limited to these substances.

The ether solvent may be dibutyl ether, tetraglyme, diglyme, dimethoxy ethane, 2-methyltetrahydrofuran, tetrahydrofuran, or the like, but is not limited to these substances.

The ketone solvent may be cyclohexanone, but is not limited to this substance.

The alcohol solvent may be ethyl alcohol, isopropyl alcohol, or the like, but is not limited to these substances.

The aprotic solvent may be a nitrile such as R—CN, wherein R is a C₂-C₂₀ linear, branched, or cyclic hydrocarbon group which may include a double-bonded aromatic ring or an ether bond, an amide such as dimethylformamide, a dioxolane such as 1,3-dioxolane, a sulfolane, or the like, but is not limited to these substances.

Examples of the nonaqueous organic solvent include ethylene carbonate (EC), ethylmethyl carbonate (EMC) and dimethyl carbonate (DMC). For example, the nonaqueous organic solvent may be a mixture of ethylene carbonate (EC), ethylmethyl carbonate (FMC) and dimethyl carbonate (DMC) in a volume ratio of 1:1:1, but is not limited to these substances.

The lithium salt contained in the electrolyte solution is dissolved in the nonaqueous organic solvent and functions as a source of lithium ions in the lithium battery to operate the lithium battery, and accelerates the migration of lithium ions between the positive electrode and the negative electrode.

For example, the lithium salt may include at least one supporting electrolyte salt selected from the group that includes LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (wherein x and y are each respectively an independently a natural number), LiCl, LiI and lithium bis(oxalate)borate (LiB(C₂O₄)₂).

The concentration of the lithium salt may be in the range of about 0.1 M to about 2.0 M, preferably, in the range of about 0.6 M to about 2.0 M, more preferably, in the range of about 0.7 M to about 1.0 M. When the concentration of the lithium salt is within the range described above, the electrolyte solution may have desired conductivity and viscosity, and thus lithium ions may be efficiently migrated.

The electrolyte solution may further include an additive capable of improving low temperature performance of the lithium polymer battery and swelling performance of the lithium polymer battery at high temperature. The additive may be a carbonate material.

For example, the carbonate material may be vinylene carbonate (VC); vinylene carbonate (VC) derivatives having at least one substituent selected from the group that includes a halogen atom (for example, —F, —Cl, —Br, and —I), a cyano group (CN), and a nitro group (NO₂); and ethylene carbonate (EC) derivatives having at least one substitutent to selected from the group consisting of a halogen atom (for example, —F, —Cl, —Br, and —I), a cyano group (CN), and a nitro group (NO₂), but is not limited to these materials.

The additive may be used alone or in a combination of at least two different materials.

The electrolyte solution may further include at least one additive selected from the group that includes vinylene carbonate (VC) and fluoroethylene carbonate (FEC).

The electrolyte solution may further include fluoroethylene carbonate as an additive.

The electrolyte solution may further include vinylene carbonate and fluoroethylene carbonate as additives.

The amount of the additive may be in the range extending from about 0.1 parts by weight to about 10 parts by weight based on 100 parts by weight of a total amount of the nonaqueous organic solvent and the lithium salt.

For example, the amount of the additive may be in the range extending from about 1 part to about 5 parts by weight, preferably, in the range extending from about 3 parts to about 4 parts by weight, based on 100 parts by weight of the total amount of the nonaqueous organic solvent and the lithium salt, but is not limited to these materials.

A lithium polymer battery according to another embodiment of the present invention may include a gel polymer electrolyte that includes a nonaqueous organic solvent, a lithium salt, an ion-conducting polymer and a fluorinated benzene; a positive electrode, and a negative electrode.

In the current embodiment, the nonaqueous organic solvent, the lithium salt, the fluorinated benzene, an ion-conducting polymer may be defined as described above.

The polymer electrolyte may be a gel polymer matrix including a product of polymerization between a (meth)acrylic polymer and a (meth)acrylic monomer. The polymer electrolyte encompasses gel type polymer electrolyte and gel-free dry type polymer electrolyte.

The lithium polymer battery may be either a primary lithium battery or a secondary lithium battery.

The positive electrode may include a current collector and a positive electrode active material layer disposed on the current collector.

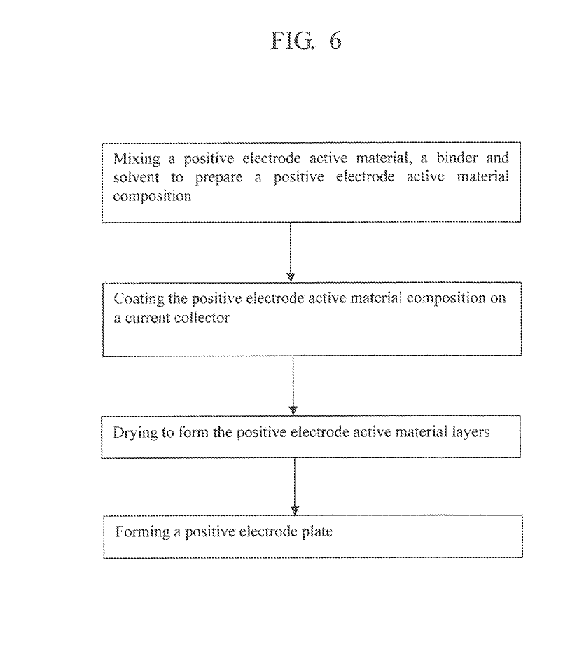

The positive electrode may be prepared according to the following process as illustrated in FIG. 6. At first, a positive electrode active material, a binder, and a solvent are mixed to prepare a positive electrode active material composition. Then, the positive electrode active material composition is directly coated on a current collector (for example, an aluminum (Al) current collector) and dried to form a positive electrode active material layer, thereby forming a positive electrode plate. Alternatively, the positive electrode active material composition may be cast on a separate support, and a film made from the positive electrode active material is separated from the separate support and then the film is laminated on a current collector to form a positive electrode active material layer, thereby forming a positive electrode plate. The method of manufacturing the positive electrode is straightforward to one of ordinary skill in the art, and thus further elaboration upon this a detailed description thereof is not provided. The solvent may be N-methylpyrrolidone, acetone, water, or the like, but is not limited to these substances.

The binder contained in the positive electrode active material layer functions to strongly bind positive electrode active material particles together and to the current collector. Examples of the binder include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The positive electrode active material in the positive electrode active material layer may include a positive electrode active material that allows reversible intercalation and deintercalation of lithium ions.

Examples of the positive electrode active material include lithium-transition metal oxides, such as LiCoO₂, LiNiO₂, LiMnO₂, LiMn₂O₄, and LiNi_{1-x-y}COₓM_{y}O₂, wherein 0≦x≦1, 0≦y≦1, 0≦x+y≦1, and M is a metal such as aluminum (Al), strontium (Sr), magnesium (Mg), or lanthanum (La), but are not limited to these substances.

The positive electrode active material may include only the Ni—Co—Mn-based active material, or may be a mixture of the Ni—Co—Mn-based active material and at least one of the lithium-transition metal oxides.

The positive electrode active material of the positive electrode active material layer may include LiCoO₂.

The positive electrode active material layer may further include a conducting agent for providing conductivity to the positive electrode. Any conducting agent inducing no chemical change in batteries may be used. Examples of the conducting agent may include carbonaceous materials, such as natural graphite, artificial graphite, carbon black, acetylene black, Ketchen black, carbon fibers, and the like; metal-based materials, such as copper (Cu), nickel (Ni), aluminum (Al), silver (Ag), and the like, in powder or fiber form; and conductive materials, including conductive polymers, such as a polyphenylene derivative, and mixtures of these substances.

The current collector may be aluminum (Al), but is not limited to aluminum.

Similarly, the negative electrode may include a current collector and a negative electrode active material layer disposed on the current collector. The negative electrode may be prepared according to the following process. A negative electrode active material, a conducting agent, a binder, and a solvent are mixed to prepare a negative electrode active material composition. The negative electrode active material composition is directly coated on a current collector (for example, a copper (Cu) current collector) and dried to form a negative electrode active material layer, thereby forming a negative electrode plate. Alternatively, the negative electrode active material composition may be cast on a separate support and a negative electrode active material film separated therefrom is laminated on a Cu current collector to obtain a negative electrode active material layer, thereby forming a negative electrode plate. In this regard, the amounts of the negative electrode active material, the conducting agent, the binder, and the solvent may be those levels commonly used in the manufacture of lithium polymer batteries.

Natural graphite, artificial graphite, a silicon/carbon complex (SiCₓ), silicon metal, a silicon thin film, lithium metal, a lithium alloy, a carbonaceous material, or graphite may be used as the negative electrode active material. The conducting agent, the binder, and the solvent the negative electrode active material composition may be the same as those used in the fabrication of the positive electrode active material composition. If required, a plasticizer may be further added to each of the positive electrode active material composition and the negative electrode active material composition in order to form pores in the electrode plates.

A separator may be optionally be interposed between the positive electrode plate and the negative electrode plate to form a battery assembly. A plurality of battery assemblies may be stacked in a bi-cell structure.

The bi-cell structure of battery assemblies is wound upon itself in a continuous series of turns, or may be folded, and then placed into a pouch used as a battery case. Then, a lithium salt, a nonaqueous organic solvent, a fluorinated benzene, and a polymer electrolyte precursor are injected into the pouch.

The resultant is heated, thereby completing the manufacture of a lithium polymer battery containing a polymer electrolyte constructed as an embodiment of the to present invention.

Any separator that is commonly used for lithium batteries may be used. For example, a separator having a low resistance to migration of ions in the electrolyte and excellent electrolyte-retaining capability may be used. Examples of materials that may be used to form the separator include glass fiber, polyester, Teflon, polyethylene, polypropylene, polytetrafluoroethylene (PTFE), and combinations of these materials, each of these materials may be a nonwoven fabric or a woven fabric.

Examples of the separator that may be used in the lithium polymer battery constructed as an embodiment of the present invention include polyethylene, polypropylene, and a combination of these materials.

Examples of the polymer electrolyte precursors for the polymer electrolyte include a (meth)acrylic polymer, a (meth)acrylic monomer, and mixtures of these materials.

When the lithium salt, the nonaqueous organic solvent, the fluorinated benzene, and the polymer electrolyte precursor are injected into the pouch, a filler, an initiator, or the like, but is not limited to these substances, may be further added.

The polymer electrolyte described above has excellent electrolyte-retaining capability. In addition, an electrode assembly including the separator described above is windable and nay therefore, be readily formed into coils of different geometric shapes.

The polymer electrolyte may be a gel polymer electrolyte including, for example, a product of polymerization between the (meth)acrylic polymer and the (meth)acrylic monomer.

According to an embodiment of the present invention, the polymer electrolytes of the lithium polymer batteries described above may be implemented as below.

A polymer electrolyte composition may be directly coated on a positive electrode or a negative electrode, and then dried, thereby forming an electrolyte membrane. Alternately, an electrolyte membrane may be formed by casting the polymer electrolyte composition onto a separate support and drying the same to obtain an electrolyte membrane, separating the electrolyte membrane from the support, and finally laminating the electrolyte membrane on a positive electrode or a negative electrode.

The separator may be interposed between the positive electrode plate and the negative electrode plate to form a battery assembly. The polymer electrolyte assembly is wound into a coil or folded, and then sealed in a pouch. Then, an electrolyte solution is injected into the pouch, thereby completing the manufacture of a lithium polymer battery.

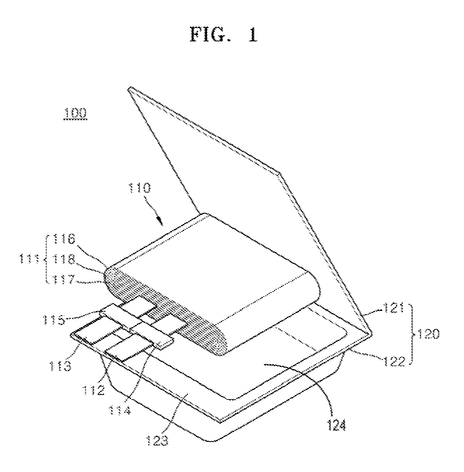

FIG. 1 is an exploded perspective view of a lithium polymer battery 100 constructed as an embodiment of the present invention, before sealing in a case.

Referring to FIG. 1, the lithium polymer battery 100, which is a pouched battery, includes an electrode assembly 110 and a case 120 that accommodates and seals the electrode assembly 110. The electrode assembly 110 includes a battery unit 111, and a positive electrode tab 112 and a negative electrode tab 113 that are respectively connected to two electrode plates of the battery unit 111.

The battery unit 111 includes a positive electrode plate 116, a negative electrode plate 117, and a separator 118 disposed between the positive electrode plate 116 and the negative electrode plate 117. The battery unit 111 may be assembled by winding the positive electrode plate 116 and the negative electrode plate 117 with the separator 118 therebetween, into a shape, for example, a coil of increasing radius, that conforms to the interior shape of a case.

The positive electrode plate 116 of the battery unit 111 is connected to the positive electrode tab 112, and the negative electrode plate 117 of the battery unit 111 is connected to the negative electrode tab 113, wherein the positive electrode tab 112 and the negative electrode tab 113 are respectively connected to different corresponding external ports. Protection tapes 114 and 115 are respectively wound around the positive electrode tab 112 and the negative electrode tab 113 to electrically insulate the positive electrode tab 112 and the negative electrode tab 113 from the case 120.

Case 120 includes a lower case 122 that accommodates battery unit 111, and an upper case 121 that seals a top surface of case 122, and an interior cavity 123. Lower case 122 has a sealing part 123 constructed with three edges. Alternatively, upper case 121 may include sealing part 123.

Although not illustrated in FIG. 1, after battery unit 111 is inserted into case 120 and then sealed, a polymer electrolyte composition including a nonaqueous solvent, a lithium salt, an ion-conducting polymer and a fluorinated benzene is injected into case 120, and then the resulting structure is optically or thermally treated, thereby completing the manufacture of lithium polymer battery 100 including a polymer electrolyte.

The lithium polymer batteries manufactured according to the principles of the present invention described above, may have a reduction in the uncharged area attained by merely using an activation process at room temperature, which leads to a marked improvement in lifetime characteristics of the Lithium polymer battery. As such, in one or more of the embodiments of the present invention; a lithium polymer battery having excellent lifetime characteristics may be manufactured through an activation process at room temperature. Thus, the time required to manufacture a lithium polymer battery and the associated manufacturing costs may be reduced, when compared to the time and costs required to manufacture a lithium polymer battery through a high-temperature activation process. Furthermore, the generation of side-reaction products, which may occur in a battery during a high-temperature activation process, may be prevented in lithium polymer batteries manufactured according to the principles of the present invention.

The activation process at room temperature may be performed at a temperature within an ideal range that extends from about 10° C. to about 50° C., for example within an operational range from about 20° C. to about 25° C. for about 1 to about 72 hours.

Substituents in the formulae (1) and (2) above may be defined as follows.

Examples of the alkyl group used herein include, but are not limited to, a methyl group, an ethyl group, a propyl group, an isobutyl group, a sec-butyl group, a pentyl group, an iso-amyl group, and a hexyl group, wherein at least one hydrogen atom of the alkyl group may be substituted with a halogen atom (for example, CCF₃, CHCF, CH₂F and CCl₃), a C₁-C₂₀ alkyl group substituted with a halogen atom, a hydroxyl group, a nitro group, a cyano group, an amino group, an amidino group, a hydrazine, a hydrazone, a carboxyl group or a salt of a carboxyl group, a sulfonic acid group or a salt of a sulfonic acid group, a phosphoric acid or a salt of a phosphoric acid, a C₁-C₂₀ alkyl group, a C₂-C₂₀ alkenyl group, a C₇-C₂₀ alkynyl group, a C₁-C₂₀ heteroalkyl group, a C₆-C₂₀ aryl group, a C₆-C₂₀ arylalkyl group, a C₆-C₂₀ heteroaryl group or a C₆-C₂₀ heteroarylalkyl group.

The aryl group used herein may be used either alone or in combination, and refers to an aromatic system containing at least one ring. Examples of the aryl group include a phenyl group, a naphthyl group, a tetrahydronaphthyl group, and the like. At least one hydrogen atom of the aryl group may be substituted with the same substituent as described above in connection with the alkyl group.

The carbon ring group used herein refers to a non-aromatic cyclic group whose atoms are all carbon, such as a cyclohexyl group. At least one hydrogen atom in the carbon ring group may be substituted with the same substituent as described above in connection with the alkyl group.

The heterocyclic group used herein refers to a ring group including a heteroatom such as N, S, P, or O. An example of the heterocyclic group is pyridyl. At least one hydrogen atom in the heterocyclic group may be substituted with the same substituent as described above in connection with the alkyl group.

Hereinafter, one or more embodiments of the present invention will be described in more detail with reference to the following examples. These examples, however, are not intended to limit the scope of the one or more embodiments of the present invention. In the following examples, the amounts of polyethylene oxide, 2-ethylhexylacrylate and hexafluorobenzene were defined in “parts by weight” based on 100 parts by weight of the total weight of ethylene carbonate (EC), ethylmethylcarbonate (EMC), dimethyl carbonate (DMC), and LiPF₆.

### Example 1

### Manufacture of a Lithium Polymer Battery

LiCoO₂ as a positive electrode active material, polyvinylidene fluoride (PVDF) as a binder, and carbon as a conducting agent were mixed in a weight ratio of 92:4:4, and then dispersed in N-methyl-2-pyrrolidone to prepare a positive electrode active material slurry. The positive electrode active material slurry was coated on an aluminum foil having a thickness of 20 μm, dried and then pressed to manufacture a positive electrode.

Meanwhile, graphite used as a negative electrode active material, styrene-butadiene rubber (SBR) used as a binder, and carboxymethyl cellulose (CMC) used as a thickening agent were mixed in a weight ratio of 96:2:2 and then dispersed in water to prepare a negative electrode active material slurry. The negative electrode active material slurry was coated on a copper foil having a thickness of 15 μm, dried and then pressed to manufacture a negative electrode.

The positive electrode and the negative electrode manufactured above were wound together, while a polyethylene (PE) separator having a thickness of 20 μm disposed between the positive electrode and the negative electrode, and then compressed and to placed into a pouch.

A mixture of an electrolyte solution having a viscosity of 4 cP or greater and a polymer electrolyte precursor, was injected into the pouch, thereby completing the manufacture of a lithium polymer battery having a capacity of about 1150 mAh.

The mixture of the electrolyte solution and the polymer electrolyte precursor was prepared by adding LiPF₆ into a nonaqueous mixed solvent of ethylene carbonate (EC), ethylmethylcarbonate (EMC) and dimethyl carbonate (DMC) in a volume ratio of 1:1:1 until the concentration of LiPF₆ reached about 1.0 M, and adding 5 parts by weight of a polyethylene oxide including an acryl group (having a weight average molecular weight of about 40,000), 2 parts by weight of 2-ethylhexylacrylate, and 0.5 parts by weight of hexafluorobenzene, each based on 100 parts by weight of the total weight of ethylene carbonate (EC), ethylmethylcarbonate (EMC), dimethyl carbonate (DMC) and LiPF₆, into the mixed solution.

### Example 2

### Manufacture of a Lithium Polymer Battery

A lithium polymer battery was manufactured in the same manner as Example 1, except that the amount of hexafluorobenzene was changed to one (1) part by weight.

### Example 3

### Manufacture of a Lithium Polymer Battery

A lithium polymer battery was manufactured in the same manner as Example 1, except that the amount of hexafluorobenzene was changed to two (2) parts by weight.

### Example 4

### Manufacture of a Lithium Polymer Battery

A lithium polymer battery was manufactured in the same manner as Example 1, except that the amount of hexafluorobenzene was changed to three (3) parts by weight.

### Example 5

### Manufacture of a Lithium Polymer Battery

A lithium polymer battery was manufactured in the same manner as Example 1, except that the amount of hexafluorobenzene was changed to 0.3 parts by weight.

### Example 6

### Manufacture of a Lithium Polymer Battery

A lithium polymer battery was manufactured in the same manner as Example 1, except that the amount of hexafluorobenzene was changed to ten (10) parts by weight.

### Comparative Example 1

### Manufacture of a Lithium Polymer Battery

A lithium polymer battery was manufactured in the same manner as Example 1, except that hexafluorobenzene was not added when preparing the polymer electrolyte composition, i.e., the mixture of the electrolyte solution and the polymer electrolyte precursor.

### Comparative Example 2

### Manufacture of a Rectangular Lithium Battery

LiCoO₂ as a positive electrode active material, polyvinylidene fluoride (PVDF) as a hinder, and carbon as a conducting agent were mixed in a weight ratio of 92:4:4, and then dispersed in N-methyl-2-pyrrolidone to prepare a positive electrode active material slurry. The positive electrode active material slurry was coated on an aluminum foil having a thickness of 20 μm, dried and then pressed to manufacture a positive electrode.

Meanwhile, graphite, as a negative electrode active material, styrene-butadiene rubber (SBR) as a binder, and carboxymethyl cellulose (CMC) as a thickening agent were mixed in a weight ratio of 96:2:2 and then dispersed in water to prepare a negative electrode active material slurry. The negative electrode active material slurry was coated on a copper foil having a thickness of 15 μm, dried and then pressed to manufacture a negative electrode.

The positive electrode and the negative electrode manufactured above were wound up, while a polyethylene (PE) separator having a thickness of 20 μm was disposed therebetween, and then compressed and inserted into a 46 mm×34 mm×50 mm rectangular can. An electrolyte solution was then injected into the can, thereby completing the manufacture of a lithium secondary battery.

The electrolyte solution was prepared by adding LiPF₆ into a nonaqueous mixed solvent of ethylene carbonate (EC), ethylmethyl carbonate (EMC), and dimethyl carbonate (DMC) in a volume ratio of 1:1:1 until the concentration of LiPF₆ reached about 1.0M.

### Comparative Example 3

### Manufacture of a Rectangular Lithium Battery

A rectangular lithium battery was manufactured in the same manner as in Comparative Example 2, except that one (1) part by weight of hexafluorobenzene, based on 100 parts by weight of the total weight of ethylene carbonate (EC), ethylmethyl carbonate (EMC), and dimethyl carbonate (DMC), was further added into the rectangular can, in to addition to the electrolyte solution.

### Evaluation Example

### 1) Uncharged Degree

After activating the lithium polymer batteries manufactured according to Examples 1 through 4 and Comparative Example 1 at a room temperature (25° C.) for about forty-eight (48) hours, the uncharged degree of the negative electrode of each of the lithium polymer batteries was determined by measurement. The results are shown in Table 1. The uncharged degree of the negative electrode was measured from the number and diameter of dark spots on the negative electrode plate.

After activating the lithium polymer batteries manufactured according to Examples 1 through 4, the amount of hexafluorobenzene in the lithium polymer batteries was reduced to 30% of the initial amount of hexafluorobenzene that was present in the original mixture of the electrolyte solution and the polymer electrolyte precursor.

### 2) Battery Characteristics

The lithium polymer batteries of Examples 1 through 4 and Comparative Example 1 were charged at room temperature at 1200 mA and 4.2V in a constant current (CC)/constant voltage (CV) mode until the current reached 60 mA, and then discharged at room temperature (25° C.) at 1200 mA and up to 2.75V. Through one cycle of charging and discharging the lithium polymer batteries underwent a formation process. After a ten minute interval, the lithium polymer batteries were charged at room temperature (25° C.) at 200 mA and 4.2V in a CC/CV mode until the current reached 60 mA, and then discharged at 1200 mA and up to 3V. After one cycle of charging and discharging, the initial capacity of each of the lithium polymer batteries was measured.

After the formation process and the measurement of the initial capacities, the lithium polymer batteries of Examples 1-4 and Comparative Example 1 were charged at 1200 mA and 4.2V in a CC/CV mode until the current reached 60 mA, and then is discharged at 1200 mA and up to 3V. This cycle of charging and discharging was repeated 200 times, followed by measuring changes in the battery capacity.

A capacity retention rate {(the capacity retention rate is the capacity after 100 cycles/1200 mA)×100} (%) was measured to measure the lifetime characteristics at room temperature.

The uncharged degrees of the lithium polymer batteries manufactured in Examples 1-4 and Comparative Example 1 were measured. The results are shown in Table 1.

TABLE 1

| | Amount of | Uncharged degree | |
|---|---|---|---|
| | hexafluorobenzene | Diameter of dark | Number of |
| Example | (part by weight) | spot (mm) | dark spots |
| Example 1 | 0.5 | 3 mm or less | 2 |
| Example 2 | 1 | 3 mm or less | 2 |
| Example 3 | 2 | 3 mm or less | 2 |
| Example 4 | 3 | 3 mm or less | 2 |
| Comparative | — | 7 mm or greater | 10 |
| Example 1 | | | |

Referring to Table 1, the uncharged degrees of the lithium polymer batteries of Examples 1 through 4 were significantly smaller than that of the lithium polymer battery of Comparative Example 1. The smaller the uncharged degree, the higher the formation capacity and the lifetime characteristics.

The capacity characteristics of the lithium polymer batteries manufactured according to Examples 1 through 4 and Comparative Example 1 were determined by making measurement that were referenced with respect to a cycle number. The results are shown in Table 2 and FIG. 2.

TABLE 2

| | Amount of | |
|---|---|---|
| | hexafluorobenzene | Capacity retention |
| Example | (part by weight) | rate (%) |
| Example 1 | 0.5 | 91 (@ 200cycle) |
| Example 2 | 1 | 90 (@ 200cycle) |
| Example 3 | 2 | 89 (@ 200cycle) |
| Example 4 | 3 | 87 (@ 200cycle) |
| Comparative | — | 30 (@ 100cycle) |
| Example 1 | | |

Referring to Table 2, the lithium polymer batteries of Examples 1 through 4 were found to have better lifetime characteristics, as compared to the lithium polymer battery used in Comparative Example 1.

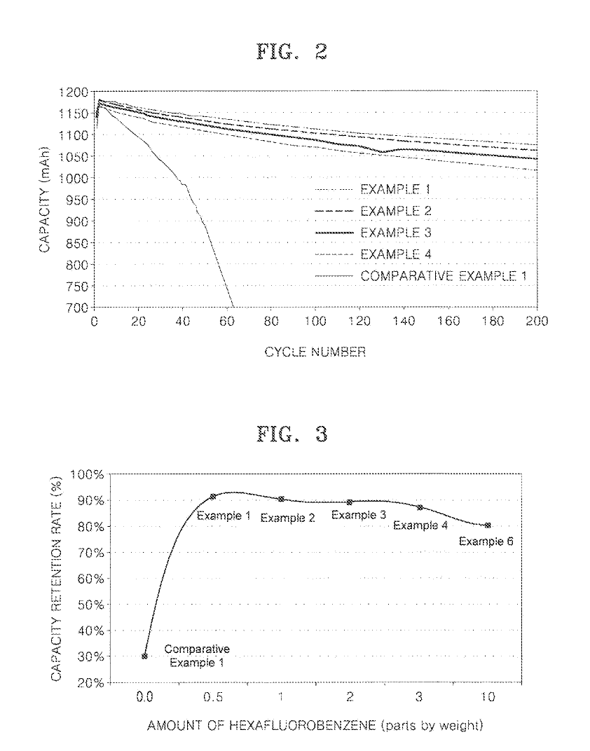

In addition, capacity retention rates of the lithium polymer batteries of Examples 1 through 6 with respect to the amount of hexafluorobenzene were measured. The results are shown in FIG. 3. The capacity of each of the lithium polymer batteries was measured after charging the batteries at room temperature (25° C.) at 1200 mA and 4.2V in a CC/CV mode until the current reached 60 mA, and discharging them at 1200 mA and up to 3V.

FIG. 3 is a graph illustrating the capacity retention rate with respect to an amount of hexafluorobenzene in lithium polymer batteries manufactured according to Examples 1 through 4, Example 6 and Comparative Example 1. Referring to FIG. 3, the capacity retention characteristics of the lithium polymer battery were excellent when the amount of hexafluorobenzene was in the range of about 0.3 to about 10 parts by weight based on 100 parts by weight of the total weight of the lithium salt and the nonaqueous organic solvent.

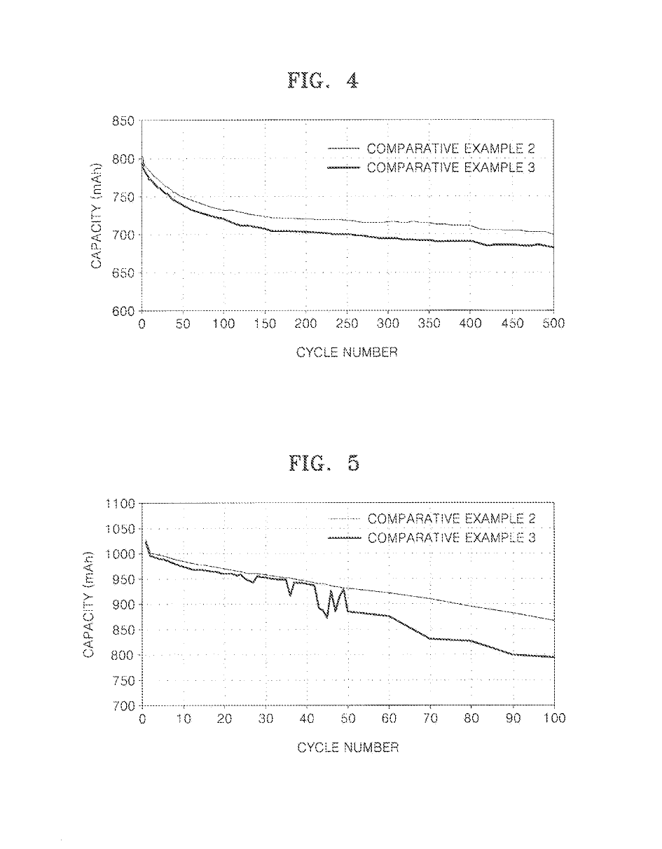

The lifetime characteristics of the rectangular lithium batteries of Comparative Examples 2 and 3 were measured after a high-temperature activation at 45° C. and a room-temperature activation at 25° C. The lifetime characteristics of each of the rectangular lithium batteries were measured after charging the batteries at 1200 mA and 4.2V in a CC/CV mode until the current reached 60 mA, and discharging the batteries at 1200 mA and up to 3V. The results are shown in FIGS. 4 and 5.

Referring to FIGS. 4 and 5, the rectangular lithium batteries used for Comparative Examples 2 and 3 were found to have poor lifetime characteristics, as compared to the lithium polymer batteries used for Examples 1 through 6. Also, the rectangular lithium batteries of Comparative Example 3 using a mixture of the electrolyte solution and the polymer electrolyte precursor including hexafluorobenzene had a similar lifetime is characteristics to the rectangular lithium batteries of Comparative Example 2. That is, an effect of hexafluorobenzene in the rectangular lithium batteries of Comparative Example 3 is trivial.

The foregoing paragraphs describe the details for the practice of a lithium polymer battery including a polymer electrolyte, or a gel polymer electrolyte, a nonaqueous organic solvent, a lithium salt, an ion-conducting polymer, and fluorinated benzene. According to the principles of the present invention, for one or more of the above embodiments, an uncharged zone occurring in a lithium polymer battery is reduced by using an activation process at room temperature (25° C.), and thus the lithium polymer battery may be manufactured with improved capacity and lifetime characteristics.

It may be understood that the exemplary embodiments described therein may be considered in a descriptive sense only and not to be construed for purposes of limitation. Descriptions of features or aspects within each embodiment may typically be considered as available for other and for similar features or aspects in other embodiments.

What is claimed is:

1. A lithium polymer battery, comprising:
a polymer electrolyte comprising a nonaqueous organic solvent, a lithium salt, an ion-conducting polymer, and fluorinated benzene;
a positive electrode; and
a negative electrode.

2. The lithium polymer battery of claim 1, wherein the fluorinated benzene comprises one material selected from the group consisting of hexafluorobenzene, pentafluorobenzene, 1,2,3,4-tetrafluorobenzene, 1,2,3,5-tetrafluorobenzene, 1,2,4,5-tetrafluorobenzene, and 1,2,3-trifluorobenzene, and mixtures of these substances.

3. The lithium polymer battery of claim 1, wherein an amount of the fluorinated benzene is in a range of about 0.3 to about 10 parts by weight based on 100 parts by weight of a total weight of the nonaqueous organic solvent and the lithium salt.

4. The lithium polymer battery of claim 1, wherein an amount of the ion-conducting polymer is in a range of about 1 to about 30 parts by weight based on 100 parts by weight of a total weight of the nonaqueous organic solvent and the lithium salt.

5. The lithium polymer battery of claim 1, wherein the ion-conducting polymer comprises a product of polymerization between a (meth)acrylic polymer and a (meth)acrylic monomer.

6. The lithium polymer battery of claim 5, wherein the (meth)acrylic monomer comprises one of 2-ethylhexylacrylate or 2-ethylhexylmethacrylate.

7. The lithium polymer battery of claim 5, wherein an amount of the (meth)acrylic monomer is in a range of about 10 to about 50 parts by weight based on 100 parts by weight of the (meth)acrylic polymer.

8. The lithium polymer battery of claim 5, wherein the (meth)acrylic polymer comprises a polyethylene oxide having a (meth)acryl group.

9. The lithium polymer battery of claim 1, wherein the ion-conducting polymer comprises a product of polymerization between a (meth)acrylic polymer and a (meth)acrylic monomer,
wherein an amount of the (meth)acrylic monomer is in a range of about 10 to about 50 parts by weight based on 100 parts by weight of the (meth)acrylic polymer.

10. The lithium polymer battery of claim 1, wherein an amount of the fluorinated benzene after an activation process at a temperature within a range of about 20 to about 25° C. is in a range of about 0.3 to about 10 parts by weight based on 100 parts by weight of a total weight of the nonaqueous organic solvent and the lithium salt.

11. The lithium polymer battery of claim 1, wherein an amount of the ion-conducting polymer after an activation process at a temperature within a range extending from about 20 to about 25° C. is in a range of about 1 to about 30 parts by weight based on 100 parts by weight of a total weight of the nonaqueous organic solvent and the lithium salt.

12. A lithium polymer battery, comprising:
a gel polymer electrolyte comprising a nonaqueous organic solvent, a lithium salt, an ion-conducting polymer and fluorinated benzene;
a positive electrode; and
a negative electrode.

13. The lithium polymer battery of claim 12, wherein an amount of the ion-conducting polymer is in a range of about 1 to about 30 parts by weight based on 100 parts by weight of a total weight of the nonaqueous organic solvent and the lithium salt.

14. The lithium polymer battery of claim 12, wherein an amount of the fluorinated benzene is in a range of about 0.3 to about 10 parts by weight based on 100 parts by weight of the total weight of the nonaqueous organic solvent and the lithium salt.

15. The lithium polymer battery of claim 12, wherein the ion-conducting polymer comprises a product of polymerization between a (meth)acrylic polymer and a (meth)acrylic monomer.

16. The lithium polymer battery of claim 15, wherein the (meth)acrylic monomer comprises one of 2-ethylhexylacrylate or 2-ethylhexylmethacrylate.

17. The lithium polymer battery of claim 15, wherein an amount of the (meth)acrylic monomer is in a range of about 10 to about 50 parts by weight based on 100 parts by weight of the (meth)acrylic polymer.

18. The lithium polymer battery of claim 15, wherein the (meth)acrylic polymer comprises a polyethylene oxide having a (meth)acryl group.

19. The lithium polymer battery of claim 12, wherein the ion-conducting polymer comprises a product of polymerization between a (meth)acrylic polymer and a (meth)acrylic monomer,
wherein an amount of the (meth)acrylic monomer is in a range of about 10 to about 50 parts by weight based on 100 parts by weight of the (meth)acrylic polymer.

20. The lithium polymer battery of claim 12, wherein an fluorinated benzene comprises one material selected from the group consisting of hexafluorobenzene, pentafluorobenzene, 1,2,3,4-tetrafluorobenzene, 1,2,3,5-tetrafluorobenzene, 1,2,4,5-tetrafluorobenzene, and 1,2,3-trifluorobenzene, and mixtures of these substances.

21. The lithium polymer battery of claim 12, wherein an amount of the fluorinated benzene after an activation process at a temperature within a range extending from about 20 to about 25° C. is in a range of about 0.3 to about 10 parts by weight based on 100 parts by weight of a total weight of the nonaqueous organic solvent and the lithium salt.

22. The lithium polymer battery of claim 12, wherein an amount of the ion-conducting polymer after an activation process at a temperature within a range extending from about 20 to about 25° C. is in a range of about 1 to about 30 parts by weight based on 100 parts by weight of a total weight of the nonaqueous organic solvent and the lithium salt.
